(19) United States
(12) Patent Application Publication
(10) Pub. No.: US 2003/0115676 A1
(43) Pub. Date: Jun. 26, 2003

(54) Tool with opposing driving and telescopic pick-up functions

(76) Inventor: Burton Kozak, Chicago, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 10/036,617

(22) Filed: Dec. 21, 2001

(51) Int. Cl. B25B 13/00

(52) U.S. Cl. 7/138

(57) ABSTRACT

A combination tool with a driving implement and a pick-up implement comprises a tool handle from which extend a driving implement in one direction and a telescopic pick-up implement in the opposite direction. The two implements are constructed and function totally independently from each other.

### BACKGROUND OF THE INVENTION

1. Field of the Invention

The present invention relates to driving tools, and more specifically to tools equipped with a telescopic pick-up wand.

2. Description of the Prior Art

As manufacturers have striven to produce ever more compact machinery and equipment, the need as developed to provide tools that would allow one to manipulate or retrieve fasteners, nuts, washers, debris, etc. . . . located outside the reach of human fingers. Often, such tools take the form of telescopic wands terminating in any of a variety of grasping or fetching implements. Two recent U.S. Pat. Nos. 5,487,576 to DuVivier (1996) and 5,878,637 to Liu (1999) are typical in that the telescopic wand extends from the same region of a hand tool that also imparts torque to whatever workpiece is to be turned by the tool. Thus a worker who is driving fasteners and wants to retrieve a fastener that he just dropped must remove the driving bit so as to access the extendable pickup device. This is cumbersome, time-consuming, and, especially, hazardous as many such tasks are performed in cramped situations, near moving machinery or high voltage terminals, where a dropped tool may cause extensive damage.

U.S. Pat. No. 5,878,637 to Liu teaches a telescopic pick-up wand that may hold a tool-bit interchangeably with a pick-up device. The disadvantage in this device is that it is limited in the size of driver tool-bits that it can employ and in the torque that can be applied thereto without damaging the pick-up wand.

Thus there is a need in the art for a tool that would combine driving and pick-up functions. Such a tool may be either manually or power driven.

### SUMMARY OF THE INVENTION

It is an object of the present invention to provide a driving tool with a telescopic pick-up wand that remedies disadvantages in the prior art.

It is a further object of the present invention to provide a driving tool with a telescopic pick-up wand that is independent of the driving function of the tool. It is a feature of the present invention that it provides for a tool handle wherein the pick-up wand and the driving shaft extend from opposing ends of the handle. It is an advantage of the present invention that the same tool can perform pick-up and driving functions without the need for first removing driving bits to get access to the pick-up means.

It is another object of the present invention to provide a telescopic pick-up wand for power driven driving tools. It is a feature of the present invention that it provides for a tool handle wherein the pick-up wand is distinct from the driving shaft. It is an advantage of the present invention that a power tool can perform pick-up functions.

In brief, the present invention provides for a tool handle from which extend a driving implement in one direction and a telescopic pick-up implement in the opposite direction. Specifically, the invention provides for a combination driving and pick-up tool comprising a handle with a first end and a second end, a driving implement extending from said first end; and a telescopic pick-up implement extending from said second end.

Further objectives, features, and advantages of the present invention will become apparent from the following detailed description with appropriate reference to the accompanying drawing.

### BRIEF DESCRIPTION OF THE DRAWING

FIG. 1A is a cross-sectional view of a tool with opposite driving and pick-up implements in accordance with features of the present invention;

FIG. 1B is an alternative extension shaft for use with the invented device, in accordance with features of the present invention; and

FIG. 2 is a cross-sectional view of a tool with opposite driving and pick-up implements with the pick-up implement recessed in the tool's handle, in accordance with features of the present invention.

### DETAILED DESCRIPTION

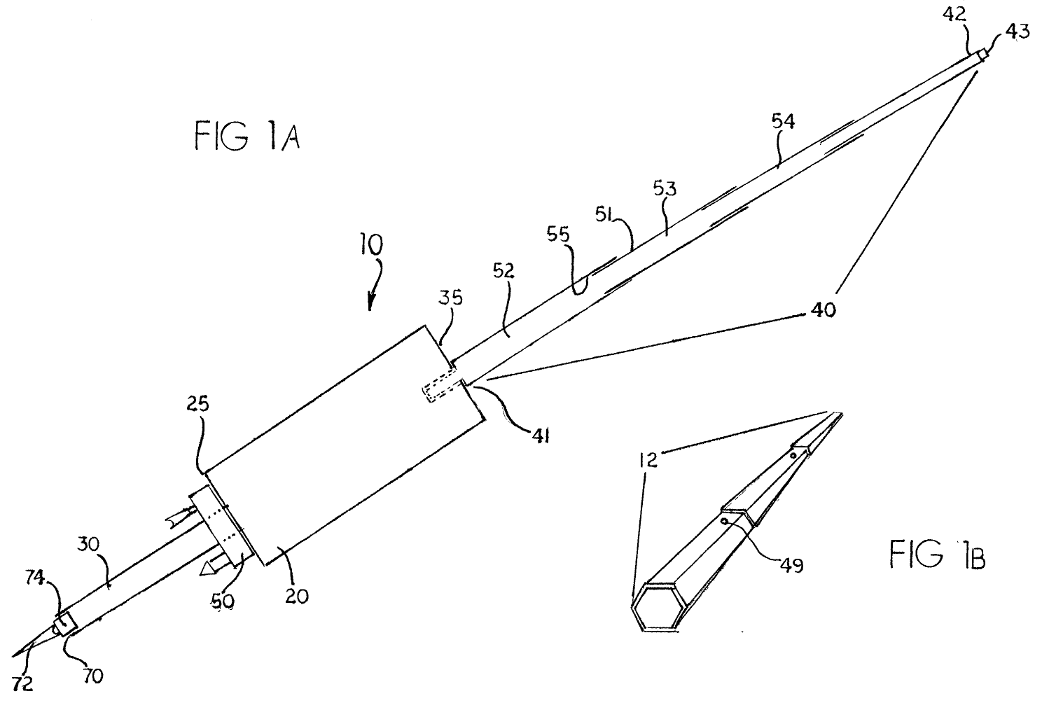

Referring to FIG. 1, the present invention provides a tool, designated as numeral 10, which comprises a torque-inducing driving implement extending in one direction and a telescopic pick-up implement extending in the opposite direction. The invented device includes a tool handle 20 with a first end 25 and a second end 35. The first end 25 extends a conventional driving tool assembly 30. The second end 35 extends a telescopic pick-up wand assembly 40.

Telescopic Member Detail

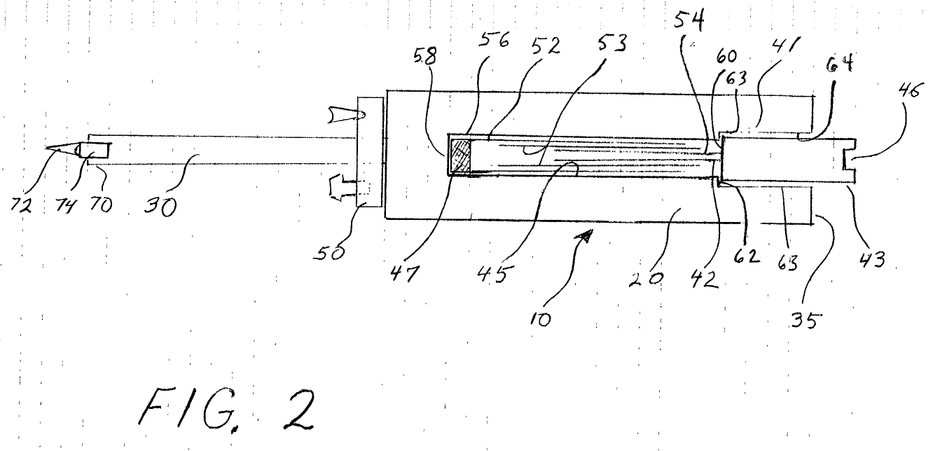

A salient feature of the invention is that the telescopic device extends in a direction generally different from the direction in which a torque-imparting shaft 30 extends. The present invention accommodates a myriad of telescopic member configurations. Also, the telescopic member (also referred to herein as the pick-up wand) is either removably attached to the tool handle 20, recessed in the handle, as shown in FIG. 2, or a combination thereof. FIG. 1 depicts the telescoping member threadably received into the second end 35 (or heel) of the handle. However, and as depicted in FIG. 2, the telescoping member can be stored, and deployed from an interior portion of the handle defining a cavity.

Generally, the telescoping member 40 comprises a first end 41 adapted to be attached to the handle, and a second end 42 adapted to retrieve hard to reach objects or detritus. The member further comprises concentrically-arranged tubular members 52, 53, 54, each with sides tapering radially inwardly relative to the longitudinal axis of the member as the member extends away from the handle. The tapered arrangement facilitates extension of the telescopic member up to the point where the tapered outer surface 51 of a second tube 53 frictionally engages a tapered inner surface 55 of a first tube 52 juxtaposed radially outward from the second tube 51. The telescopic member may be extended to its full length by pulling on the second end 42.

One may prevent azimuthal relative motion between the concentrically-arranged tubular members by using tubular members having non-circular cross-sections, such as square or hexagonal cross-sections.

The telescoping member 40 is attached to an exterior region of the handle (such as its heel), or to an inside surface of the handle, by any of a variety of means. Such means include, but are not limited to, a press fit arrangement, a snap fit arrangement, or a male-female threaded configuration, the latter configuration of which is depicted in FIG. 1A.

The telescoping member could be permanently attached to the handle, so as to be collapsed after use and hidden way inside the handle. Conversely, the telescoping member can be reversibly attached to the handle. In one exemplary attachment configuration, the telescopic member is adapted to be threaded into a threaded aperture located on the handle.

FIG. 1B depicts another embodiment 12 of the telescoping member 40. This embodiment 12 shows the telescopic member with hexagonal cross section. Also shown is a ball lock 49 mechanism to reversibly lock the member in an extended configuration, said configuration depicted in FIG. 1B. The ball-lock mechanism is any standard spring ball lock configuration comprising a spherical body slidably received in an aperture formed in a surface opposing the spherical body when the telescopic member is fully extended. It should be noted that the spring ball configuration also can be utilized with a telescopic wand having a circular cross section, or other geometry.

FIG. 2 depicts the invented device wherein the telescopic member 50 is stored in an interior region of the handle 20 of the tool 10. The interior region defines a cavity 45, coaxial with the longitudinal axis of the handle. The cavity is adapted to house the telescopic member 50 when the telescopic member is un-deployed. The telescopic member 50 may be secured to the cavity 45 by a variety of means, a press fit among others. A press fit attachment is facilitated by forming a knurled section 47 on the end of the outer surface of the outermost tube 53. In the case where the telescopic member is to be permanently attached to the tool, the proximal end 56 of the first tube 52 is knurled so as to frictionally engage with a complementarily shaped female aperture 58 of the cavity, the aperture extending in the direction opposite the direction of extension of the telescopic member. In the case where the telescopic member is to be reversibly attached to the handle, the proximal end 56 of the first tube 52 is threaded to facilitate its engagement with a threaded aperture defined by the female aperture 58.

In its un-deployed state the telescopic implement may be used as a magnetic nut setter and driver. Such an embodiment is illustrated in FIG. 2 where a standard size nut setter 43 such as a 5/16 inch hexagonal nut setter is attached to the distal end 42 of the telescopic wand. FIG. 2 depicts the nut setter fully nested in an aperture 64 formed at the distal end 63 of the cavity 45. The aperture 64 is formed of similar cross section to that of the nut setter so as to slidably receive the nut setter, but prevent axial rotation of the nut setter when the setter is nested inside the aperture.

The nut setter is affixed reversibly (for example in a snap fit or a male-female threaded configuration) to the end 42 of the telescopic wand and comprises a hexagonal cavity 46 sized to receive a nut. The nut setter may be magnetic. The nut setter serves an additional function of preventing the terminal end of the telescope member from slipping completely within the confines of the cavity. In this regard, a proximal end 60 of the nut setter 43 comes to rest (when the telescopic member is in the fully retracted position) against an annular shoulder 62 defined by the proximal end 63 of the aperture 64.

Alternatively the cross section of the cavity can be configured to slidably receive but rotatably confine standard driver bits. A bit confined in this instance is not physically connected to the telescopic member 40 but would be metallic so as to draw the end of the telescopic member 42 (heretofore equipped with the magnetic tip 43) from the confines of the handle cavity 45 when the bits are removed from the aperture 64.

Methods of fabricating a tool wand as described above are well known. Typically light metallic materials are employed. Also, one may use plastic or other non-electrically conducting materials such as ceramic non-static materials so that the pick-up tool may be used in the immediate vicinity of microchips. In addition to the enhanced safety factor, the use of such materials avoids causing electric short-circuits in the presence of electric wiring or machinery.

Telescopic Member Detail

The distal end 42 of the telescopic member terminates with a means for retrieving objects. If the objects to be retrieved are ferrous-containing materials, a magnetic substrate is attached to the end 42. An exemplary magnetic substrate is a nut setter such as a standard 5/16th of an inch sized setter.

If the objects to be retrieved are non-ferrous-based materials, and perhaps detritus (dust, wood shavings, plastic fasteners, and the like), a scoop, hook, or bit (wherein the bit is complementarily shaped to the targeted material) is removably secured to the end 42.

Furthermore, the end 42 may in addition (or, in the alternative) terminate in a male screw thread capable of receiving a pick-up tool comprising a cavity with a matching female thread. Other pick up tools and means to hold same are known in the art and these may be utilized in conjunction with the present invention.

Although the telescopic member is intended primarily for pick-up functions, it may also be used, when this is indicated, as a driving tool for a remote fastener. In that case the distal end 42 is adapted to hold an hexagonal bit holder adapted to receive fastener-engaging bits.

Various pick-up devices may be stored on a bit holding assembly via frictional fit on an exterior region of the handle or else inside a cavity in the handle.

Handle Detail

As shown in FIG. 1, an embodiment of the present invention comprises a standard tool handle 20 with a tool driving implement 30 extending from one end of the handle and a telescopic pick-up wand 40 extending from the opposite end. In all essential particulars the driving tool/handle combination is identical to manual- or power driven-screw (or other) drivers that are commercially available at present. The pick-up wand/handle combination is standard as well.

As noted supra, the telescopic member can be either attached to an outer surface of the handle 20 as depicted in FIG. 1 or else nested inside the handle, as depicted in FIG. 2. An external attachment configuration may be preferred when the tool in question is a power tool. Under these circumstances one usually prefers that the innards of the tool handle be reserved for the tool power plant (electric motor or air turbine).

The telescopic member 40 also may be embedded inside the handle of a power tool where the handle of the tool is not along the line of action of the tool but perpendicular or otherwise inclined thereto.

Extension and retraction of the telescopic member is performed manually. One may extend the pick-up wand by attaching the telescopic member 40 to the heel 35 and then pulling manually. In the alternative, one may allow the shaft end 42 to project from the handle even when the wand is fully retracted.

As shown in FIG. 1, the tool also may comprise a circumferential bit-holding assembly 50. The bit-holding assembly may be used to store pick-up tools. This assembly may take the form of a slip-on annulus slidably received by the fastener driving shaft 30. Alternatively, the bit holding means may consist of an array of cavities formed in the handle so as to store bits in a friction-fit capacity.

Another bit-holding embodiment is disclosed in “A Hand Tool with Opposing Drive Ends and Storage for Multiple Tool Bits,” U.S. pat. application Ser. No. 09/918,958 with the same inventor as the present invention. U.S. pat. application Ser. No. 09/918,958 discloses a tool with a handle, a driving shaft, an annulus that is slidably received by the driving shaft and whereon bits are stored with their driving end pointing towards the handle. The handle itself may comprise an annular cavity coaxial with the driving shaft so configured that the annulus may be slid up against the handle until all the bits are wholly contained therein. Furthermore, one may provide a window opening parallel to the driving shaft on the side of said cavity so that one may access a bit stored in said cavity by rotating the annulus until the desired bit comes into view.

A great variety of materials may be used to fabricate the handle. These include, but are not limited to wood, plastics, rubber, KEVLAR, fiberglass, Bakelite, resins, etc. . . .

Driving Tool Details

There are no limitations on the driving tool assembly 30. Any presently available driver assembly may be employed and the present invention does not address the driver assembly as such. It may consist of a shaft terminating in a standard working tool configuration, such as a straight blade 72, a Philips tip, a socket, a threaded aperture, a threaded rod, a quick-disconnect, or standard accessories with a 5/16 inch hex rear and ¼ inch front. Alternatively, the terminal end of the shaft may define an aperture adapted to receive a variety of different tool bits. In such instances, the end of the shaft would interact with the bits in a standard socket-insert configuration, whereby the end of the shaft defines a female socket adapted to receive a complementary shaped insert 74. Typically, non-circular sockets and inserts are utilized to prevent turning of the inserts. An exemplary socket size suitable for the end 70 of the driving portion is a one-quarter-inch hex female socket.

In summary, the present invention provides for a tool handle from which extend a driving implement in one direction and a telescopic pick-up implement in a different direction. The two implements are constructed and function totally independently from each other.

Although the present invention has been described with a certain degree of particularity, the described embodiments have been presented by way of example only and numerous modifications and alterations may be made thereto without departing from the spirit and scope of the invention as set forth in the appended claims.

The embodiment of the invention in which an exclusive property or privilege is claimed is defined as follows:

1. A combination driving and pick-up tool comprising:
a handle with a first end and a second end;
a driving implement extending from said first end; and
a telescopic pick-up implement extending from said second end.

2. The combination tool as recited in claim 1 wherein said driving implement is manually-driven.

3. The combination tool as recited in claim 1 wherein said driving implement is power-driven.

4. The combination tool as recited in claim 1 wherein said driving implement may be used in conjunction with a plurality of tool bits.

5. The combination tool as recited in claim 1 wherein said handle comprises tool bit storing cavities.

6. The combination tool as recited in claim 1 wherein said pick-up implement comprises a plurality of concentrically aligned tubes with a common longitudinal axis.

7. The combination tool as recited in claim 7 wherein said concentrically arranged tubes have a non-circular cross-section.

8. The combination tool as recited in claim 7 wherein said tubes are electrically insulative.

9. The combination tool as recited in claim 1 wherein said telescopic pick-up implement terminates with a magnet.

10. The combination tool as recited in claim 1 wherein said telescopic pick-up implement comprises means to receive detachable bits.

11. The combination tool as recited in claim 1 wherein said handle defines a cavity that receives a tool bit storing assembly in slidable communication with said driving implement.

12. The combination tool as recited in claim 11 wherein tool bits stored in said storing assembly are wholly confined in said cavity.

13. The combination tool as recited in claim 12 wherein tool bits stored in said storing assembly are accessible by means of an opening in said handle.

14. The combination tool as recited in claim 5 wherein said cavities are electrically insulated from the handle.

15. The combination tool as recited in claim 1 wherein said pick-up implement comprises a nut setter.

16. A combination driving and pick-up tool comprising:
a handle with a first end and a second end, said handle comprising tool bit storing cavities;
a driving implement extending from said first end adapted to be used in conjunction with a plurality of tool bits.; and
a telescopic pick-up implement extending from said second end and comprising a plurality of electrically insulative concentrically aligned tubes with a common longitudinal axis.

17. The combination tool as recited in claim 16 wherein said telescopic pick-up implement terminates with a magnet.

18. The combination tool as recited in claim 16 wherein said telescopic pick-up implement is terminated with a removably attached nut setter.

19. The combination tool as recited in claim 16 wherein said concentrically arranged tubes have a non-circular cross-section.

20. The combination tool as recited in claim 16 wherein said handle, driving implement, and pick-up implement are aligned along an identical longitudinal axis.
